(19) United States
(12) Patent Application Publication
(10) Pub. No.: US 2017/0328071 A1
(43) Pub. Date: Nov. 16, 2017

(54) WALL CLADDING SYSTEM AND FASTENER

(71) Applicant: HWH GREEN HOT WATER PTY LTD, Preston, Victoria (AU)

(72) Inventor: Wesley Leonard REYNOLDS, Warrandyte, Victoria (AU)

(73) Assignee: HWH GREEN HOT WATER PTY LTD, Preston, Victoria (AU)

(21) Appl. No.: 15/537,777

(22) PCT Filed: Dec. 17, 2015
(86) PCT No.: PCT/AU2015/050805

§ 371 Date: Jun. 19, 2017

(30) Foreign Application Priority Data
Dec. 19, 2014 (AU) 2014905160
Aug. 28, 2015 (AU) 2015903488

(51) Int. Cl. E04F 13/08; B32B 27/32; E04C 2/24; E04B 1/76; B32B 5/24; F16B 15/06; B32B 27/06

(52) U.S. Cl. CPC E04F 13/0835; B32B 27/065; B32B 27/32; E04C 2/243; E04B 1/7629; B32B 5/245; F16B 15/06; E04C 2/246; B32B 2262/101; B32B 2266/0214; B32B 2607/00

(57) ABSTRACT

A cladding system for a building structure. The system includes a multilayered panel and at least one fastener including a base portion securable to the frame, and a barbed portion projecting from the base portion for penetrating at least a rear face and backing layer of a section of the panel. The barbed portion includes a cental planar member with barbs extending laterally to each side of the central planar member and is sized such that the front face of the panel is not penetrated by the fastener when the panel is secured to the wall frame.

### RELATED APPLICATIONS

The present application is a National Phase entry of PCT Application No. PCT/AU2015/050805, filed Dec. 17, 2015, which claims priority from AU Patent Application No. 2014905160, filed Dec. 19, 2014, and which claims priority from AU Patent Application No. 2015903488, filed Aug. 28, 2015, said applications being hereby incorporated by reference herein in their entirety.

### TECHNICAL FIELD OF THE INVENTION

The present invention relates to building construction. More particularly the invention relates to a cladding system and fastener for securing cladding panels to a building structure. Embodiments of the invention are especially suited for wall cladding purposes, and it will be convenient to describe embodiments of the invention in relation to that example application. It should be understood however that the cladding system and fastener are also intended for covering other parts of building structures such as for lining ceilings and floors, including balcony floors.

### BACKGROUND TO THE INVENTION

The exterior walls of building structures, for example residential homes, are in some instances constructed by applying a series of cladding panels to an underlying framework of the building structure so as to provide a continuous wall cladding. The panels are typically made of a foam material, for example expanded polystyrene, to provide thermal insulation. The foam panels are normally secured to the framework or wall frame of the building structure, usually timber studs in residential homes, by holding each panel against the underlying wall frame and driving screws through the panel and into the studs. A mesh tape is then applied across abutting edges of adjoining panels prior to the application of multiple layers of render to the abutting edges and external/front face of each panel.

A problem with this type of wall cladding structure is that the screws used to secure the panels to the frame are prone to rusting, which can lead to cracking of the render and unsightly rust marks appearing on the external surface of the panels and hence the render. Attempts have been made in the past to address this problem by increasing the thickness of each layer of render. However this increases the time, complexity and hence cost involved in installing the wall cladding.

It would therefore be desirable to provide an alternative method for fixing cladding panels to an underlying frame or substrate such that the fixing means does not penetrate the front face of the panels.

### SUMMARY OF THE INVENTION

One aspect of embodiments of the present invention accordingly provides a cladding system for a building structure, the system including:

a multilayered panel having a first side providing a front face of the panel and a second side providing a rear face of the panel,

the front face being part of a first section of the panel and the rear face being part of a second section of the panel,

the first section of the panel including an insulating layer and the second section of the panel including a backing layer,

the system further including at least one fastener for fastening the panel to a wall frame of the building structure,

the fastener including a base portion securable to the wall frame, and a barbed portion projecting from the base portion for penetrating at least the rear face and backing layer of the second section of the panel to thereby secure the panel to the wall frame,

wherein the barbed portion of the fastener is sized such that the front face of the panel is not penetrated by the fastener when the panel is secured to the wall frame.

In one embodiment, the rear face of the panel is provided by the backing layer. The backing layer is preferably a semi-rigid material which is soft enough to be penetrable by the barbed portion of the fastener but hard enough to provide sufficient holding strength once the barbed portion has penetrated the backing layer. The backing layer could, for example, be a thin cementitious screed over a polypropylene mesh but, in a preferred embodiment, is a fluted material, such as fluted polypropylene. This material is generally referred to as “Corflute” in Australia or “Twinwall polypropylene” in the United States.

In another embodiment, the insulating layer is made of expanded polystyrene. This material preferably has a density of between approximately 10 kg/m³ and 240 kg/m³, and more preferably somewhere around 45-50 kg/m³.

In a further embodiment, the first section of the panel also includes a protective layer. Preferably the front face of the panel is provided by this protective layer. The protective layer may advantageously be a phenolic resin impregnated fiberglass, as this material has been found to be particularly suitable.

In one embodiment, the barbed portion of the fastener is generally planar in shape and has a central planar member. In this embodiment the barbs of the barbed portion extend laterally from the central planar member. In a more preferred embodiment, at least one barb extends in a first direction generally away from the planar member and at least one barb extends in a second direction opposite the first direction. In other words, barbs extend from each side of the planar member.

In an embodiment where the barbed portion includes a planar member and the backing layer of the panel is made of a fluted material, the fastener is preferably secured to the wall frame such that planar member of the fastener extends substantially at a right angle to a longitudinal direction of the fluted material. For extruded Codlute material, the planar members are perpendicular to the extrusion direction of the Corflute. In this embodiment, the barbs extend away from the planar member generally along the longitudinal direction of the fluted material.

In a preferred embodiment, the base portion of the fastener has a fixing surface for securing the fastener to the wall frame and the fixing surface is generally perpendicular to the barbed portion. In this way, the base portion of the fastener may be secured to an outer face of the wall frame with the barbed portion projecting outwardly therefrom. The rear face of the panel may then be pushed against an end of the barbed portion to thereby enable the barbed portion to penetrate at least the rear face and backing layer of the panel.

In one embodiment, the base portion and barbed portion of the fastener are integrally formed from a single sheet of material which is bent at 90°. Preferably, the material is galvanised steel. In an alternative embodiment, the fastener may be made from a plastic material, such as polypropylene, and in this embodiment the base portion and barbed portion may be integrally formed using an injection molded process.

Another aspect of embodiments of the invention provides a multilayered panel having features as described above which enable the panel to be used in a cladding system for a building structure.

A further aspect of embodiments of the invention provides a fastener having features as described above which enable the fastener to be used in a cladding system for a building structure. More particularly, this aspect of embodiments of the invention provides a fastener for securing a cladding panel to a building structure, the fastener including:

a base portion securable to the building structure; and

a barbed portion projecting from the base portion,

wherein the barbed portion is configured to penetrate a rear face of the cladding panel and has a length which extends into a thickness of the panel, and

wherein the barbed portion includes a central planar member with barbs extending laterally to each side of the central planar member, such that in use the barbed portion secures the cladding panel to the building structure.

This type of fastener may be used with a multilayered panel as described above, or it may be used with a panel having merely a single homogeneous layer, or as will be appreciated, it could be used with a panel of any other internal single or multilayered construction. For example, such a panel may include one or more layers of materials that have the ability to accept the barbed portion of the fastener and hold the panel in place, such as an EPS, PUR or PIR material.

A further aspect of embodiments of the invention provides a method of manufacturing a fastener of the type described above. The method includes the steps of:

providing a sheet of material, preferably a sheet of galvanised steel;

bending the sheet at 90 degrees to form a base portion and a planar member projecting from the base portion; and

forming barbs in the planar member by bending portions of the sheet material away from the plane of the planar member so as to form barbs extending laterally to each side of the planar member.

To assist the further understanding of the invention, reference will now be made to the accompanying drawings which illustrate preferred embodiments. It is to be appreciated that these embodiments are given by way of illustration only and the invention is not to be limited by this illustration.

### BRIEF DESCRIPTION OF THE DRAWINGS

FIG. 1 shows a cross-sectional view of a multi-layered panel in accordance with a preferred embodiment of the invention.

FIG. 2 shows a photograph of a corner section of a prototype panel in accordance with the embodiment shown in FIG. 1.

FIG. 3 shows a portion of a wall frame of a building structure having fasteners secured thereto in accordance with an embodiment of the invention.

FIGS. 4A to 4D show photographs of a prototype fastener in accordance with one embodiment of the invention.

FIG. 5 shows another fastener in accordance with an alternative embodiment of the invention.

FIG. 6 shows top, front and side views of a fastener in accordance with a further embodiment of the invention

FIGS. 7A to 7D show photographs of the fastener depicted in FIG. 6 in its final form.

### DETAILED DESCRIPTION

Referring generally to the accompanying drawings, there is shown various components of a cladding system for a building structure in accordance with preferred embodiments of the invention.

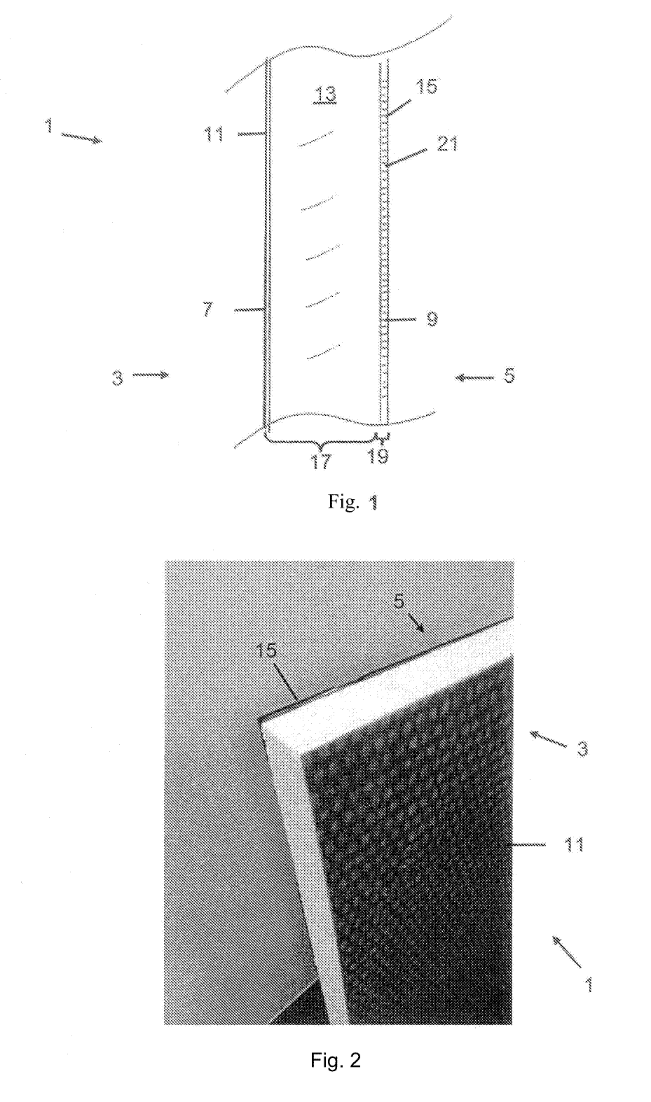

Referring now specifically to FIGS. 1 and 2, the cladding system includes multilayered panels 1, each having a first side 3 and a second side 5. The first side forms a front face 7 of the panel 1 and the second side forms a rear face 9. In the embodiment shown, the panel 1 is a three-layered structure having an outer protective layer 11, a central insulating layer 13 and a backing layer 15. The protective layer 11 and insulating layer 13 together form a first section 17 of the panel 1 and the backing layer 15 forms a second section 19. However, it will be appreciated that the panel may include a number of additional layers within either section. For example, a moisture barrier layer may be included, a fire proof layer may be included and/or additional sound absorption layers may also be included.

The backing layer 15 in the embodiment shown is a fluted material, such as extruded Corflute, made of polypropylene. FIG. 1 shows a cross-sectional view of the panel 1 in which the individual flutes 21 can be seen ‘end-on’. In this regard, it has been found that a fluted material advantageously provides stiffness to the panel while also improving its insulating qualities.

The insulating layer 13 may be made of conventional expanded polystyrene or a more advanced insulating material. For example, polyurethane foam (PUR) may be used or polyisocyanurate foam (PIR) may alternatively be used. The PUR insulating material may have a density of up to 240 kg/m3, and PIR normally would have a workable density of up to 60 kg/m3, to accept the barbed fastener (as described further below).

Finally, the protective layer 11 is a phenolic resin impregnated fiberglass. This material forms a tough skin providing rigidity to the panel and also a high degree of impact resistance.

The various layers of the multilayered panel 1 may be fixed together by a suitable adhesive. Depending on the materials chosen for the layers, a number of different adhesives might be appropriate. The selection of suitable adhesives would be readily apparent to a person skilled in the art and need not therefore be described in further detail.

Referring now to FIG. 3, there is shown a portion of a building structure having a wall frame 23. In this embodiment, the wall frame includes a plurality of timber studs 25 extending between a top plate 27 and a bottom plate 29. However, it will be appreciated that the wall frame may take any form and could instead use a metal framework or could be of a concrete slab construction. In any event, the “wall frame” forms a substrate to which the panels of the cladding system can be secured.

Also shown in FIG. 3 is a plurality of fasteners 31 secured to an outer face of the studs 25 of the wall frame 23. These fasteners 31 may take a number of preferred forms as will be described below. In each form, the length of the fasteners 31 is less than the thickness of the intended panels.

In an alternative embodiment (now shown), the panels 1 may be secured to other parts of a building structure. For example, panels designed to provide a thermal, acoustic or fire barrier may be secured to other parts of a building structure such as a ceiling, especially ceilings within a multi-storey residential building, or a floor. In the latter regard, balcony floors must often be sealed to prevent water from an upper floor leaking into the ceiling of a lower floor. The panel and ‘blind fixing’ fastener of the present invention make this type of installation quicker and simpler. Since the panel is not penetrated by the fastener, only the joints between the panels need to be sealed. This can be done using conventional sealants, so the whole process can be undertaken much more quickly.

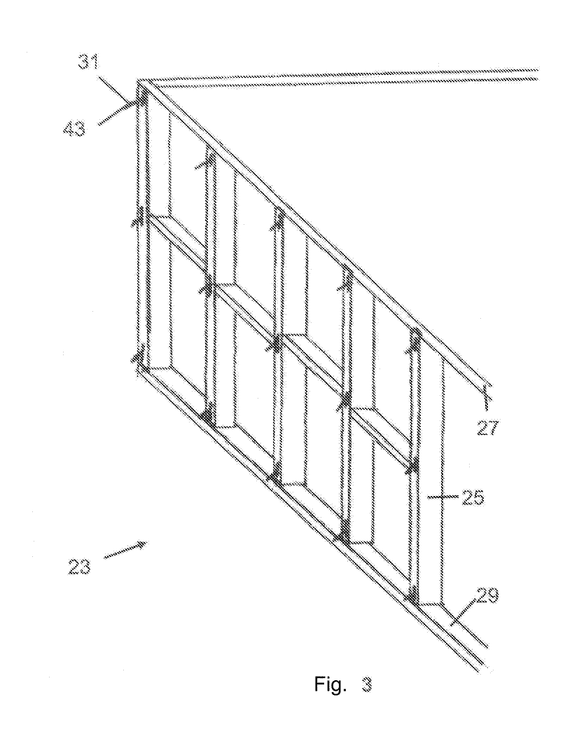

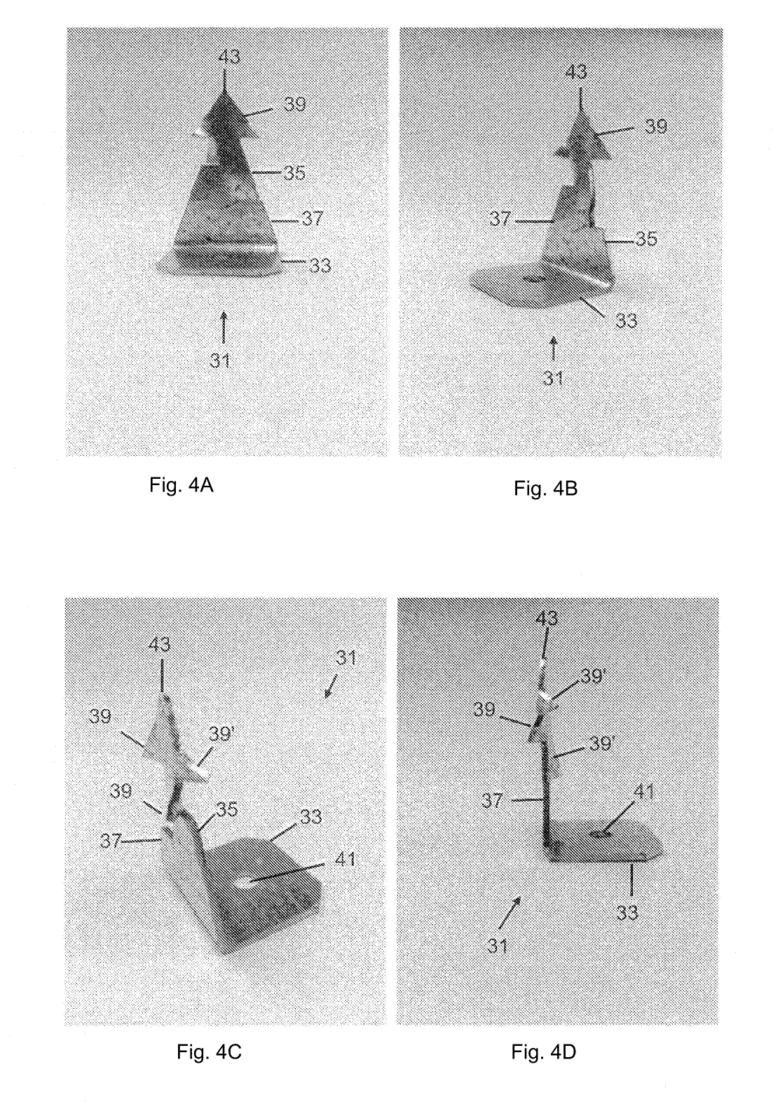

Referring now to FIGS. 4A to 4D, there is shown a first embodiment of a prototype fastener 31 in accordance with the overall principles of the invention. This fastener is formed from a single sheet of galvanised steel which has been bent at 90° so as to form a base portion 33 and a barbed portion 35 extending at right angles to the base portion 33. In this embodiment, the barbed portion 35 is generally planar in shape having a central planar member 37 and a plurality of barbs 39 extending laterally from the plane of the planar member 37. As can be best seen in FIGS. 4C and 4D, at least one barb 39 extends in a first direction away from the plane of the planar member 37 and at least one barb 39′ extends in a second direction opposite the first direction. Thus, in the orientation of the fastener as shown in FIG. 4D, a first barb 39 projects to the left of the planar member 37 and a second barb 39′ extends to the right of the planar member 37.

To enable the fastener 31 to be secured to the wall frame 23, a hole 41 is provided in the base portion 33. More than one hole may be provided but one has been found to be sufficient. The upper end (with the fastener oriented as shown in FIGS. 4A to 4D) has a sharp point 43 to enable the fastener 31 to penetrate the rear face 9 and backing layer 15 of the panel 1.

In use, the fasteners 31 are secured to the wall frame 23 by screwing the base portion 33 of each fastener to an outer face of each stud 25. Any suitable screw may be used (according to the material of the stud 25) by inserting it through the hole 41 in the base portion 33 and driving it into the stud 25. A panel 1 is then positioned against the outwardly projecting points 43 of the fasteners 31 and pushed horizontally towards the wall frame 23 so that the fasteners 31 pierce the rear face 9 of the panel 1 and penetrate at least the backing layer 15 to thereby secure the panel 1 to the wall frame 23.

Preferably, the length of the barbed portion 35 of the fastener 31 is selected such that it penetrates a substantial distance into the insulating layer 13 but not so far that it contacts the protective layer 11. The barbed configuration then helps to prevent the fasteners 31 being extracted from the panel 1. In this regard, the relative resilience of polystyrene insulating material enables the barbed portion of the fastener to penetrate the material but the resilience of the polystyrene then causes the material to close in around the barbs and thereby prevent them being pulled back out.

To further secure the wall panel 1 to the fasteners 31, and hence to the wall frame 23, a suitable adhesive may be applied to the all or part of the fastener 31 as well as to an area of the wall stud 25 surrounding the fastener 31. In trials conducted by the inventor, a 5 mm bead of Fuller HPR25 adhesive has been found to be suitable but a variety of other construction adhesives could alternatively be used. Suitable alternatives would be readily apparent to a person skilled in the art and need not be described further.

Although the fasteners 31 could be secured to the studs 25 with the planar member 37 of the fastener having any orientation, it is preferred that they are installed such that the planar member 37 extends substantially at right angles to a longitudinal direction of the fluted material. In other words, the plane of the fastener extends across the extrusion direction of the fluted material. With this orientation, the barbs 39 extend away from the planar member 37 in the extrusion direction of the fluted material. For example, if the multilayered panels are made such that the extrusion direction of the fluted material is vertical (extending from the top plate 27 to the bottom plate 29 of the wall frame 23 shown in FIG. 3) then the planar members 37 of the fasteners 31 should be installed so that they extend horizontally.

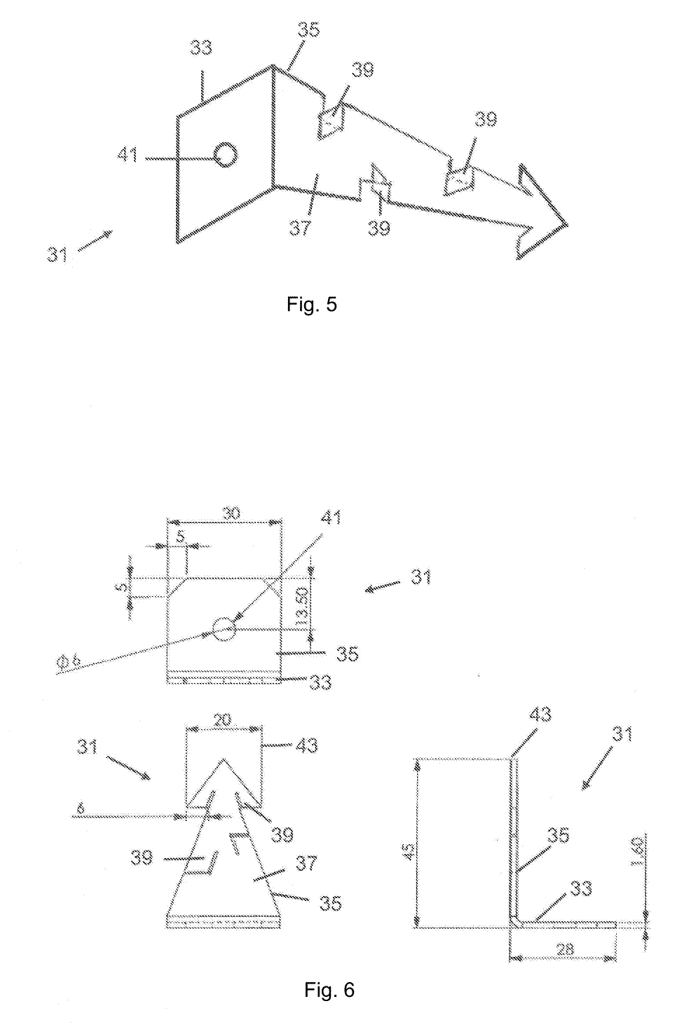

Referring now to FIG. 5, there is shown an alternative embodiment of a fastener which, in many respects, is similar to the fastener 31 shown in FIGS. 4A to 4D. For this reason, identical reference numerals are used to identify corresponding features of the fastener 31 shown in FIG. 5.

The primary difference between the fastener shown in FIG. 5 and that shown in FIGS. 4A to 4D is in the formation of the barbs 39. In this embodiment the fastener 31 is again formed of sheet metal which has been bent at 90° to form a base portion 33 and a barbed portion 35. The material has however been cut differently in the region of the barbs 39 such that they are bent, at about 45 degrees, away from the planar member 37 about axes which extend across the length of the planar member and parallel to the base portion 33. In contrast, the barbs of the fastener shown in FIGS. 4A to 4D are bent away from the planar member 37 about axes which extend along the length of the planar member 37. In both instances, however, a barb 39 is formed so as to prevent the panel 1 being pulled away from the base portion 33 of the fasteners 31.

FIG. 6 shows a further embodiment of the invention which is very similar to that shown in FIG. 5 and, again, identical reference numerals have been used to identify corresponding features. In this instance, however, the barbs 39 have not yet been bent outwardly from the plane of the planar member 37. These drawings thus show an intermediate step in the formation of the fastener 31.

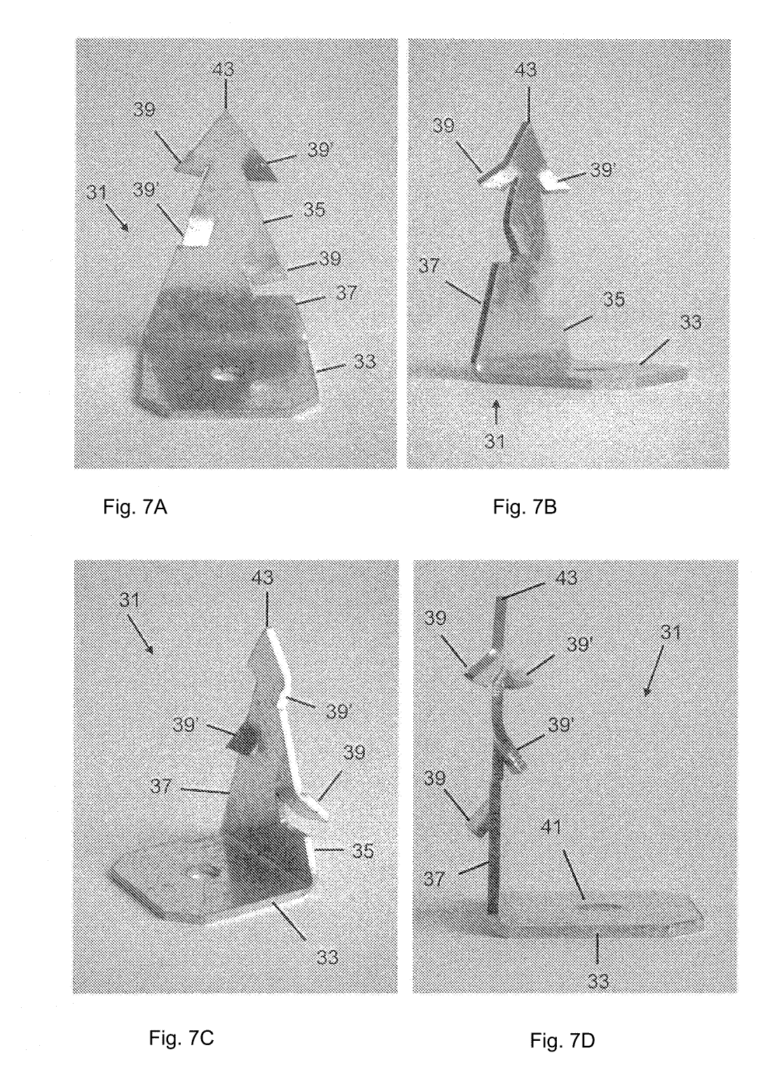

Finally, FIGS. 7A to 7D show a number of photographs of the fastener shown in FIG. 6 after the barbs 39 have been bent outwardly away from the central planar member 37. In this embodiment it can been seen that the fastener 31 is again formed from a single sheet of galvanised steel which has been bent at 90 degrees so as to form a base portion 33 and a barbed portion 35 extending at right angles to the base portion 33. Again, the barbed portion 35 has a central planar member 37 and a plurality of barbs 39 extending laterally from the plane of the planar member 37. More particularly, the barbs 39 are bent away from the planar member 37 about axes which are aligned with the plane of the planar member 37 and perpendicular to the length of the planar member 37. In the embodiment shown, these axes are parallel to the base portion, since the base portion extends at right angles to the length of the barbed portion. The photographs show the barbs 39 being bent at approximately 45 degrees from the planar member 37 but it will be appreciated that a smaller or greater angle could be used. The key point is that the barbs present a retaining surface which faces rearward, towards the base portion of the fastener, to prevent, or at least resist, the panel being removed from the fastener. Similar to the embodiment shown in FIGS. 4A to 4D, alternate barbs 39, 39′ extend in opposite directions from the planar member 37.

In all embodiments, the cladding system of the invention provides a rapid construction process. The fasteners are firstly secured to the wall frame or other building structure, construction adhesive is applied to each fastener and to the area surrounding each fastener, and then the panel is pushed against the fasteners so as to provide a “blind” fixing without any penetration of the front face of the panel. Once all the panels are installed, mesh tape is applied across abutting edges of adjoining panels, the same as in prior art cladding systems, and render is then applied across all panels so as to form a continuous rendered surface.

A major advantage of the wall cladding system of the present invention, however, is that the front face of each panel has not been penetrated by any fasteners and the possibility of rust stains appearing through the render is completely eliminated.

Although preferred embodiments of the invention have been described herein in detail, it will be understood by those skilled in the art that variations may be made thereto without departing from the spirit of the invention or the scope of the appended claims.

1. A cladding system for a building structure, the system including:
a multilayered panel having a first side providing a front face of the panel and a second side providing a rear face of the panel,
the front face being part of a first section of the panel and the rear face being part of a second section of the panel,
the first section of the panel including an insulating layer and the second section of the panel including a backing layer,
the system further including at least one fastener for fastening the panel to a frame of the building structure,
the fastener including a base portion securable to the frame, and a barbed portion projecting from the base portion for penetrating at least the rear face and backing layer of the second section of the panel to thereby secure the panel to the frame,
wherein the barbed portion of the fastener is sized such that the front face of the panel is not penetrated by the fastener when the panel is secured to the wall frame.

2. A cladding system as claimed in claim 1 wherein the rear face of the panel is provided by the backing layer and the backing layer comprises a semi-rigid material.

3. A cladding system as claimed in claim 2 wherein the backing layer is a fluted material, preferably comprising polypropylene.

4. A cladding system as claimed in claim 1 wherein the insulating layer has a density between approximately 10 kg/m³ and 240 kg/m³.

5. A cladding system according to claim 4 wherein the insulating layer comprises expanded polystyrene.

6. A cladding system as claimed in claim 1 wherein the first section of the panel further includes a protective layer, the front face of the panel being provided by the protective layer.

7. A cladding system as claimed in claim 6 wherein the protective layer comprises a phenolic resin impregnated fibreglass.

8. A cladding system as claimed in claim 1 wherein the barbed portion of the fastener is generally planar in shape with barbs extending laterally from a central planar member.

9. A cladding system as claimed in claim 8 wherein at least one barb extends in a first direction away from the planar member and at least one barb extends in a second direction opposite the first direction.

10. A cladding system as claimed in claim 1 wherein the rear face of the panel is provided by the backing layer and the backing layer comprises a semi-rigid fluted material, preferably comprising polypropylene,
wherein the barbed portion of the fastener is generally planar in shape with barbs extending laterally from a central planar member, and
wherein in use, the planar member of the fastener is arranged to extend substantially at right angles to a longitudinal direction of the fluted material and the barbs extend away from the planar member generally along the longitudinal direction of the fluted material.

11. A cladding system as claimed in claim 1 wherein the base portion of the fastener has a fixing surface for securing the fastener to the wall frame and the fixing surface is perpendicular to the barbed portion such that, in use, the base portion is securable to an outer face of the wall frame with the barbed portion projecting outwardly therefrom.

12. A cladding system as claimed in claim 1 wherein the base portion and barbed portion of the fastener are integrally formed from a single sheet of material, preferably galvanised steel, bent at 90 degrees.

13. A cladding system as claimed in claim 1 wherein the base portion and barbed portion of the fastener are integrally formed from a plastics material, preferably injection moulded polypropylene.

14. A fastener for securing a cladding panel to a building structure, the fastener including:
a base portion securable to the building structure; and
a barbed portion projecting from the base portion,
wherein the barbed portion is configured to penetrate a rear face of the cladding panel and has a length which extends into a thickness of the panel, and
wherein the barbed portion includes a central planar member with barbs extending laterally to each side of the central planar member, such that in use the barbed portion secures the cladding panel to the building structure.

15. A fastener as claimed in claim 14 wherein the base portion and barbed portion are integrally formed from a single sheet of material, preferably galvanised steel, bent at 90 degree.

16. A fastener as defined in claim 14 wherein the barbs diverge from the central planar member by being bent away from the plane of the planar member about axes which are aligned with the plane and extend perpendicularly to the length of the planar member.

17. A method of manufacturing a fastener, including the steps of:
providing a sheet of material, preferably a sheet of galvanised steel;
bending the sheet at 90 degrees to form a base portion and a planar member projecting from the base portion; and
forming barbs in the planar member by bending portions of the sheet material away from the plane of the planar member so as to form barbs extending laterally to each side of the planar member.
